(19) United States
(12) Patent Application Publication
(10) Pub. No.: US 2004/0237091 A1
(43) Pub. Date: Nov. 25, 2004

(54) Method and system for program conversion

(76) Inventors: Alando M. Ballantyne, Austin, TX (US); Lawrence C. Van Sickle, Austin, TX (US)

Correspondence Address: BAKER BOTTS L.L.P., 2001 ROSS AVENUE, 6TH FLOOR, DALLAS, TX, 75201, US

(21) Appl. No.: 10/443,121

(22) Filed: May 20, 2003

(51) Int. Cl. G06F 13/00

(52) U.S. Cl. 719/313

(57) ABSTRACT

According to one embodiment of the invention, a computerized method for converting a conversational program to a pseudoconversational program is provided. The method includes identifying a send command and a corresponding receive command in the conversational program. The method also includes modifying the conversational program to save a state of the conversational program prior to an execution of the send command and to stop execution after the execution of the send command without executing the receive command. The method also includes modifying the conversational program to restore, when an input is received in response to executing the send command, any saved state prior to execution of the receive command.

### TECHNICAL FIELD OF THE INVENTION

This invention relates generally to computer programs and more particularly to a method and system for program conversion.

### BACKGROUND OF THE INVENTION

A computer network allows computers to interact with each other from different locations. For example, information or functions available on a server may be accessible to a terminal through the computer network. The server may facilitate such access by transmitting a web page to the terminal describing information necessary to retrieve specific information or perform a particular function. To enable such interaction with a terminal, a computer program that may be characterized as either conversational or pseudoconversational may be executed at the server.

A conversational program often refers to a server program that sends a request for information, such as a web page, to a terminal and then waits for an input from the terminal by maintaining a connection with the terminal. Waiting for an input generally requires system resources at the server. A pseudoconversational program often sends an analogous request for input to a terminal, but does not use system resources between the time when the request is sent and input is received in response. Thus, fewer system resources may be required to execute a pseudoconversational program than a conversational program, which allows more users to concurrently use the system.

### SUMMARY OF THE INVENTION

According to one embodiment of the invention, a computerized method for converting a conversational program to a pseudoconversational program is provided. The method includes identifying a send command and a corresponding receive command in the conversational program. The method also includes modifying the conversational program to save a state of the conversational program prior to an execution of the send command and to stop execution after the execution of the send command without executing the receive command. The method also includes modifying the conversational program to restore, when an input is received in response to executing the send command, any saved state prior to execution of the receive command.

Some embodiments of the invention provide numerous technical advantages. Other embodiments may realize some, none, or all of these advantages. For example, according to one embodiment, system resources are conserved at a server by converting an existing conversational program into a pseudoconversational program.

Other advantages may be readily ascertainable by those skilled in the art.

### BRIEF DESCRIPTION OF THE DRAWINGS

Reference is now made to the following description taken in conjunction with the accompanying drawings, wherein like reference numbers represent like parts, in which:

FIG. 1 is a schematic diagram illustrating one embodiment of a communications network system that may benefit from the teachings of the present invention;

FIG. 2 is a block diagram illustrating one embodiment of a program conversion system of FIG. 1;

FIG. 3A is a block diagram illustrating example code sets of a conversational program;

FIG. 3B is a block diagram illustrating one embodiment of code sets of a pseudoconversational program that may be generated from the conversational program shown in FIG. 3A;

FIG. 4 is a flowchart illustrating one embodiment of a method for converting the conversational program of FIG. 3A to the pseudoconversational program of FIG. 3B;

FIG. 5A is a block diagram illustrating example code sets of a conversational program having a decision construct;

FIG. 5B is a block diagram illustrating one embodiment of code sets of a pseudoconversational program that may be generated from the conversational program of FIG. 5A using the method of FIG. 4; and

FIG. 6 is a flowchart illustrating one embodiment of a method for converting a procedure having a send command and a receive command into a pseudoconversational format.

### DETAILED DESCRIPTION OF EXAMPLE EMBODIMENTS OF THE INVENTION

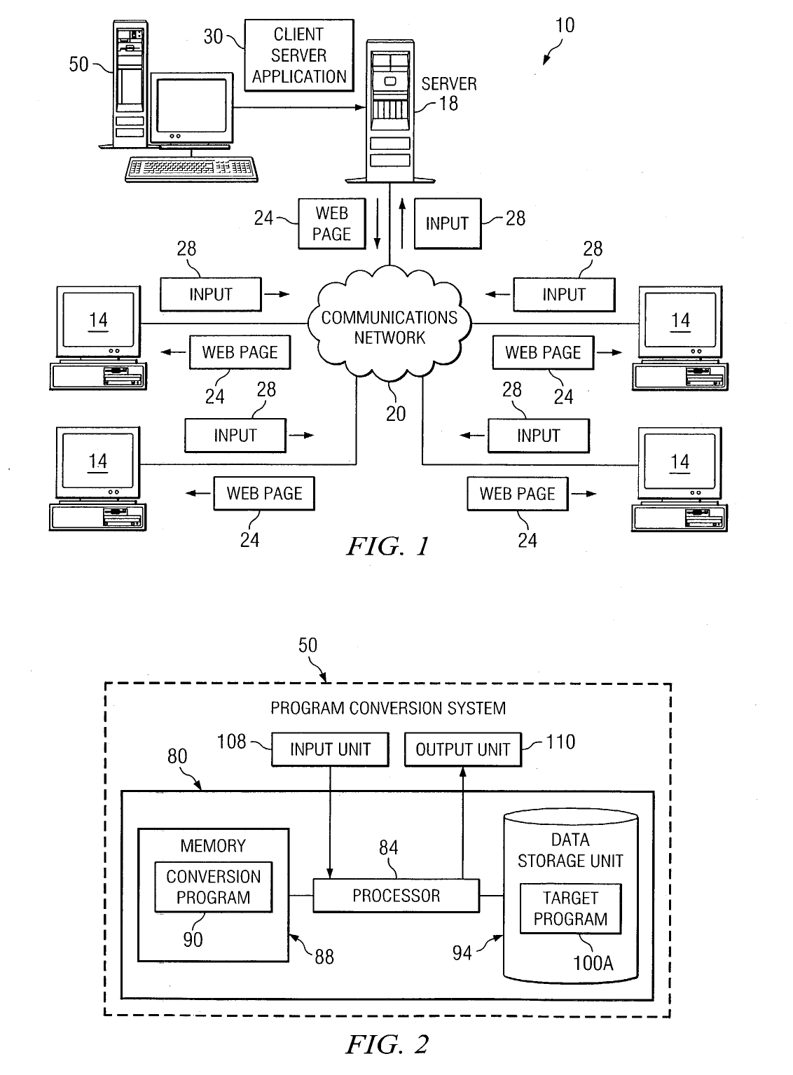

Embodiments of the invention are best understood by referring to FIGS. 1 through 6 of the drawings, like numerals being used for like and corresponding parts of the various drawings.

FIG. 1 is a schematic diagram illustrating one embodiment of a communications network system 10 that may benefit from the teachings of the present invention. System 10 comprises a plurality of terminals 14 that are coupled to a server 18 through a communications network 20, such as the Internet, an intranet, various types of area networks (wide area network, local area network, etc), a wireless network, an optical network, a satellite network, or any other suitable types of network. Terminal 14 and server 18 may by any computing system operable to communicate with each other over network 20.

Server 18 may include information and/or functionality that may be accessed with any one of terminals 14 over network 20. To provide such access, server 18 may transmit a request 24 for information, such as a web page 24, to terminals 14, and in response, receive an input 28 from terminals 14. For example, server 18 may be operable to provide driving directions to a particular location. In such an example, server 18 may transmit request 24 to terminal 14 for input 28 regarding a start address and a destination address. Once input 28, having the entered start and destination addresses, is received server 18 may formulate a route plan using the input 28 and communicate the route plan to terminal 14. Server 18 may be operable to perform any other function or access any other information and make such function and/or information available to terminals 14. Further, any type of information may be requested using request 24, such as information concerning network security and identity verification.

Request 24 transmitted from server 18 to terminals 14 may be in a variety of forms. For example, as indicated in FIG. 1, request 24 may be in the form of a web page describing the nature of the request. Request 24 may also be referred to as web page 24; however, any other suitable form of information request may be used. To make information and/or functionality of server 18 available to terminals 14, a client server application 30 may be provided to server 18 for storage and execution. Client server application 30 is a set of instructions that allows server 18 to request information from terminals 14, receive an input from terminals 14 in response to the request, and perform one or more functions using the received input. Client server application 30 may be written in any suitable computer language, including COBOL, C, or C++.

Client server applications 30 may be characterized as either a conversational program or a pseudoconversational program. A conversational program refers to a program that maintains a logical connection between the computer on which it resides, in this case server 18, and another computer, in this case terminal 14, during the time when request 24 is sent and input 28 is received; however, a server-client relationship between the involved computers is not required for a program to be deemed a conversational program. Thus, a conversational program waits for input 28 to arrive after request 24 is sent to terminal 14. Because conversational programs wait for input 28 to arrive, conversational programs generally use a higher percentage of server's 18 resources than pseudoconversational programs during that time period. A pseudoconversational program refers to a program that does not maintain a connection between the computer on which it resides, in this case server 18, and another computer, in this case terminal 14, during the time when request 24 is sent and input 28 is received; however, a server-client relationship between the involved programs residing in their respective computers is not required for a program to be deemed a pseudoconversational program. Because a pseudoconversational program does not wait for input 28 after request 24 is sent, fewer server resources are required during that time period for program execution. An existing conversational program may benefit from some of these advantages if replaced with a pseudoconversational conversational program.

According to one embodiment of the present invention, a method and system for converting a conversational program into a pseudoconversational program are provided. In one embodiment, system resources are conserved at a server by converting an existing conversational program into a pseudoconversational program. However, in some embodiments, conversion of a conversational program to a pseudoconversational program may occur according to the teachings of the invention without realizing these advantages. Additional details of example embodiments of the invention are described below in greater detail in conjunction with FIGS. 1 through 6.

Referring back to FIG. 1, a program conversion system 50 may be used to convert an existing conversational client server application into a pseudoconversational application. In turn, server 18 may store and execute the converted application 30 to interact with terminals 14 over network 20. Because the converted application 30 is a pseudoconversational program, server 18 may commit fewer resources for the execution of converted program 30 while allowing terminals 14 to communicate with server 18 as if a conversational program is being executed at server 18.

FIG. 2 is a block diagram illustrating one embodiment of program conversion system 50 shown in FIG. 1. System 50 comprises a computer 80, and an input unit 108 and an output unit 110 coupled to computer 80. Computer 80 comprises a processor 84, a memory unit 88 storing a conversion program 90, and a data storage unit 94 storing a target program 100A. Processor 84 is coupled to memory 88 and data storage unit 94. Processor 84 is also coupled to input unit 108 and output unit 110. Processor 84 is operable to execute the logic of conversion program 90 to convert target program 10A, which is conversational, into a pseudoconversational program. Examples of processor 84 are PENTIUM processors available from Intel Corporation.

Conversion program 90 is a computer program for identifying certain “send” and “receive” commands within target program 100A and modifying these identified portions to convert target program 100A into a pseudoconversational program. Additional details concerning program 90 are provided below in conjunction with the description of FIG. 4. Program 90 may reside in any storage medium, such as memory 88 or data storage unit 94. Program 90 may be written in any suitable computer language, including COBOL, C or C++.

Target program 100A may be any existing conversational program, such as a conversational client server application. Program 100A may be written in any suitable computer language, including COBOL, C, or C++. Because many client server applications are written in COBOL, COBOL is used as an example language for program 100A; however, target program 100A may be in any other suitable computer language.

Memory 88 and data storage unit 94 may comprise executable programs, files, stacks, databases, or any other suitable forms of programs or data. Memory 88 and data storage unit 94 may be random access memory, read only memory, CD ROM, removable memory devices, or any other suitable devices that allow storage and/or retrieval of data. Memory 88 and data storage unit 94 may be interchangeable and may perform the same functions. In one embodiment, a pseudoconversational program converted from target program 100A may be stored in memory 88 and or data storage unit 94.

Input device 108 may be any device operable to provide input from a user to computer 80. Output device 110 may be any device operable to communicate information generated by computer 50 to a user. Examples of input unit 108 include a keyboard, a mouse, and a touch screen monitor. Examples of output unit 110 include a monitor, printer, and a speaker.

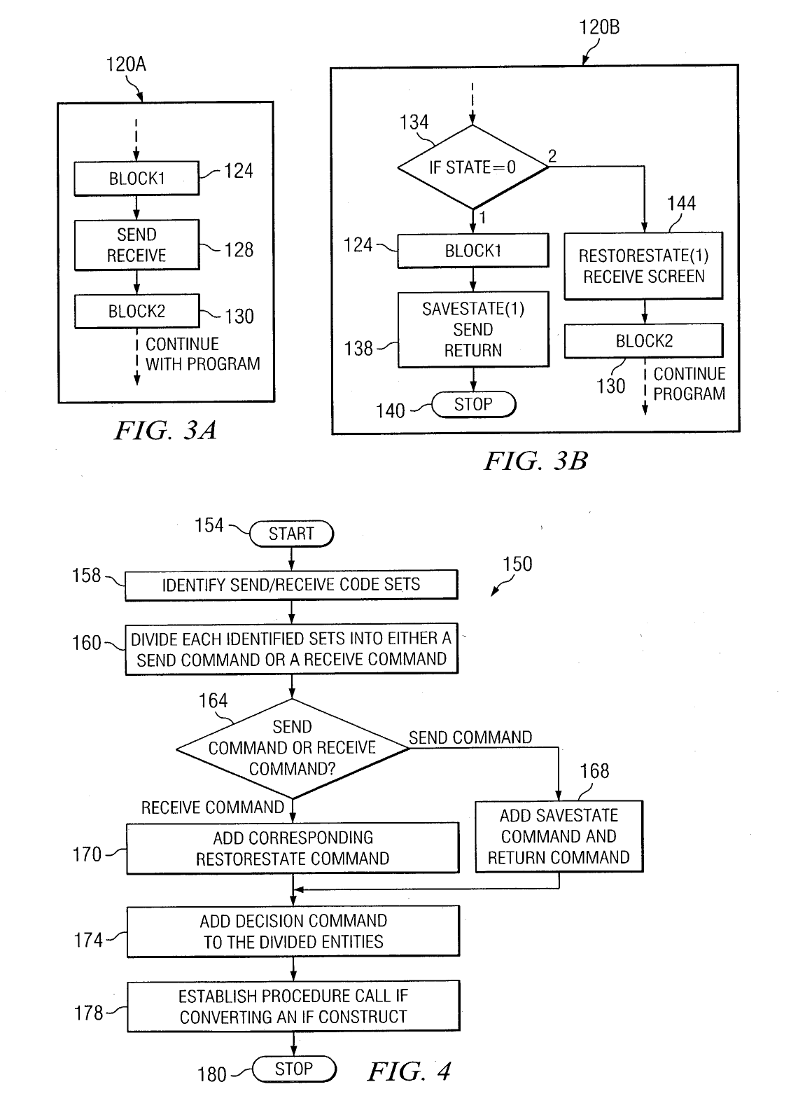

FIG. 3A is a block diagram illustrating one example execution flow of a conversational program 120A. Program 120A may be target program 100A shown in FIG. 1. Program 120A comprises a plurality of code blocks 124, 128, and 130. As used herein, a block of code or a code block, as shown in FIG. 3A, may also be referred to as a code set. Code blocks 124 and 130 each represent a code set operable to perform a particular function. Code block 128 is a code set operable to send a request for information and wait until an input is received. Thus, program 120A is operable to perform the function of block 124, then send a request for information and wait until an input is received and then perform the function of block 130. Any sets of code operable to perform analogous functions may be used as code blocks 124, 128, and 130 of program 120A. Examples of the particular functions of blocks 124, 128, and 130 are as follows. Block 124 may be operable to generate a road map of an area selected by a user of terminal 14 and generate a web page asking whether the user wants to see driving directions. Block 128 may be operable to send the web page generated by block 124 to terminal 14, and wait until another screen that includes an input is received at server 18. Block 130 may be operable to generate driving directions using the received input.

The code blocks shown in FIG. 3A may be coded using any suitable computer language or programming style. Example code representing the block diagram shown in FIG. 3A is provided below:

| | |
|---|---|
| 10 | BLOCK 1 |
| 20 | SEND 1 |
| 30 | RECEIVE 1 |
| 40 | BLOCK 2 |

In the example above, “BLOCK 1” and “BLOCK 2” each indicate a particular set of code operable to perform a particular function.

FIG. 3B is a block diagram illustrating one embodiment of example code sets of a pseudoconversational program 120B that may be generated from code sets of program 120A shown in FIG. 3A. As with program 120A, program 120B comprises code blocks 124 and 130. However, as shown in FIG. 3B, blocks 124 and 130 are now in separate branches that are tied by a state decision block 134. Program 120B also comprises blocks 138 and 144, which are modified versions of code block 128 shown in FIG. 3A. Block 138 is in the same branch as block 124 and operable to be executed after block 124. Block 144 is in the same branch as block 130 and operable to be executed before block 130.

State decision block 134 is a set of code operable to determine whether a state of a program has been previously saved. An example of state decision block 134 is an IF construct; however, any other set of code operable to make a decision may also be used. State decision code block 134 is operable to initiate an execution of code blocks 124 and 138 after a determination that a state of program 120B has not been previously saved. Code block 134 is also operable to initiate an execution of code blocks 144 and 130 after a determination that a state of program 120 has been previously saved.

Code block 138 comprises a command operable to save a state of program 120B, command operable to send a request for information, and a code operable to halt the execution of program 120B. In one embodiment, a “state” of a program refers to at least one of the fixed values that are assigned to the variables of a program at a particular stage of the execution of the program. Thus, saving a state of program 120B refers to saving at least one fixed value that is assigned to a variable at a particular stage of the execution of program 120B. Examples of functions in the COBOL programming language that may be included in block 138 to perform the functions of saving a state, sending a request, and halting the program execution include “SAVESTATE”, “SEND SCREEN”, and “RETURN”, respectively, as shown by code block 138 of FIG. 3B; however, any type of programming in any suitable computer language that is operable to perform analogous functions may also be used. The cessation of the execution of program 120B after an execution of block 138 is indicated by reference number 140.

Code block 144 comprises a command operable to restore the saved state and receive input from a client. Examples of such functions in the COBOL programming language include “RESTORESTATE”, and “RECEIVESCREEN”, respectively, as shown by code block 144 of FIG. 3B; however, any type of programming in any suitable computer language that is operable to perform analogous functions may also be used.

In one embodiment, code blocks 138 and 144, which are modified versions of code block 128 shown in FIG. 3A, allow pseudoconversational program 120B to send an information request to a client, and then halt the execution of program 120B until an input is actually received from the client. Rather than waiting for a particular input in response to an information request, halting the execution of program 120B until a response to the information request is received frees resources that are committed to the execution of program 120B. In one embodiment, state decision block 134 allows pseudoconversational program 120B to present an appearance of a conversational program to terminal 14 by initiating commands for stopping and restarting the execution of program 120B at appropriate times. In one embodiment, an application server operable to manage pseudoconversational programs may be used to start up program 120B, save a state according to a command in code block 138, and restore a state according to a command in code block 144. Examples of application server include CICS or WEBSPHERE, which are commercially available.

The code blocks shown in FIG. 3B may be coded using any suitable computer language or programming style. Example programming representing the block diagram shown in FIG. 3B is provided below:

10 IF STATE = 0 THEN
20 BLOCK 1
30 SAVESTATE 1
40 SEND 1
50 RETURN
60 ELSE
70 RESTORESTATE
80 RECEIVE 1
90 BLOCK 2
100 END IF

FIG. 4 is a flowchart illustrating one embodiment of a method 150 for converting conversational program 120A shown in FIG. 3A into pseudoconversational program 120B shown in FIG. 3B. Some or all of the acts of method 150 may be implemented using program 90; however, any other suitable software or hardware implementation may be used. Method 150 starts at step 154. At step 158, program 90 identifies the send and receive code block 128 of program 120A. Code block 128 may be identified by searching for any feature of a block that is operable to send a request for information and wait for a response. For example, any code set having the command “SEND” and the corresponding command “RECEIVE” in program 120A, as shown on lines “20” and “30” of a set of commands provided above representing the block diagram of FIG. 3A, may be identified as send and receive block 128. In one embodiment, each command for sending a request and each corresponding command for receiving a response may be identified separately rather than as a block, but corresponding send and receive commands are associated with each other. At step 160, each identified code block 128 is divided into either a send command or a receive command. For example, the “SEND 1” command at line “20” may be identified as a send command of code block 128 and the “RECEIVE 1” command of line “30” may be identified as a receive command of code block 128. In one embodiment where send and receive commands are individually identified rather than as a block at step 158, step 160 may be omitted.

At decision step 164, whether each command is a send command or a receive command is determined. If the command is a send command, then the “SEND COMMAND” branch is followed to step 168. At step 168, a command operable to save a state of a program is added so that the command is executed prior to the identified send command. In one embodiment, the added command is operable to save only the necessary variables that will be used by the converted program after the execution of the corresponding receive command. Such a variable is referred to herein as a “live variable.” Also at step 168, a command operable to halt the execution of the program is added so that the command is executed subsequent to the execution of the identified send command. An example result of performing step 168 is shown as block 138 of FIG. 3B, which corresponds to lines “30,” “40,” and “50” of an example code set provided above that represents the block diagram of FIG. 3B. Then method 150 proceeds to step 174.

Referring back to decision step 164, if the command is a receive command, then the “RECEIVE COMMAND” branch is followed to step 170. At step 170, a command operable to restore any previously saved state is added so that the command is operable to be executed prior to an execution of the identified receive command. In one embodiment, the command for restoring a previously saved state that is added at step 170 is operable to restore only the live variables. An example result of performing step 170 is shown as block 144 of FIG. 3B, which corresponds to lines “70” and “80” of an example code set provided above that represents the block diagram of FIG. 3B. Then method 150 proceeds to step 174. At step 174, a state decision block, such as code block 134 of FIG. 3B, is added to tie the modified code blocks that were generated at steps 168 and 170. In one embodiment, an IF construct may be used as a state decision block; however, any suitable set of commands operable to make a decision may be used. An example result of performing step 168 is shown as block 134 of FIG. 3B, which corresponds to lines “10,” “60,” and “100” of an example code set provided above that represents the block diagram of FIG. 3B.

In one embodiment, at step 178, a procedure call may be established if the code sets identified at step 158 and/or 160 are a part of a decision code set that is nested within another decision code set. When such a nested construct in a conversational program is converted to a pseudoconversational program using steps 154 through 174, one or more code blocks associated with the nested decision code set may have to be coded multiple times, which is an undesirable programming style. Additional details of step 178 are provided below. In some embodiments, step 178 may be omitted. Method 150 stops at step 180.

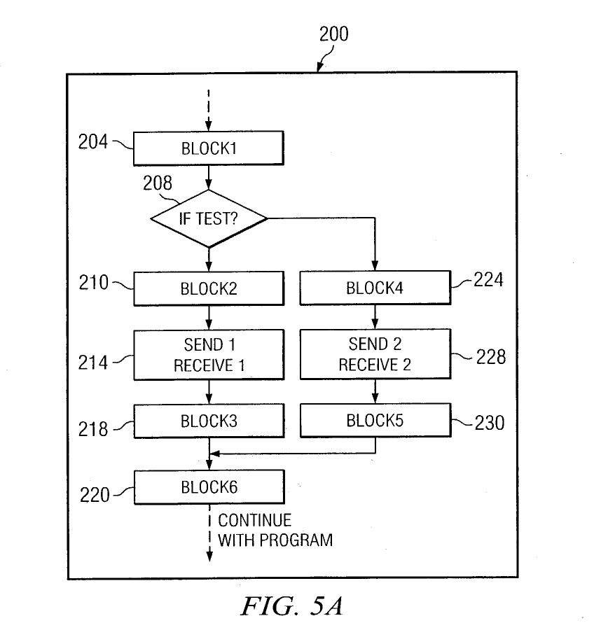

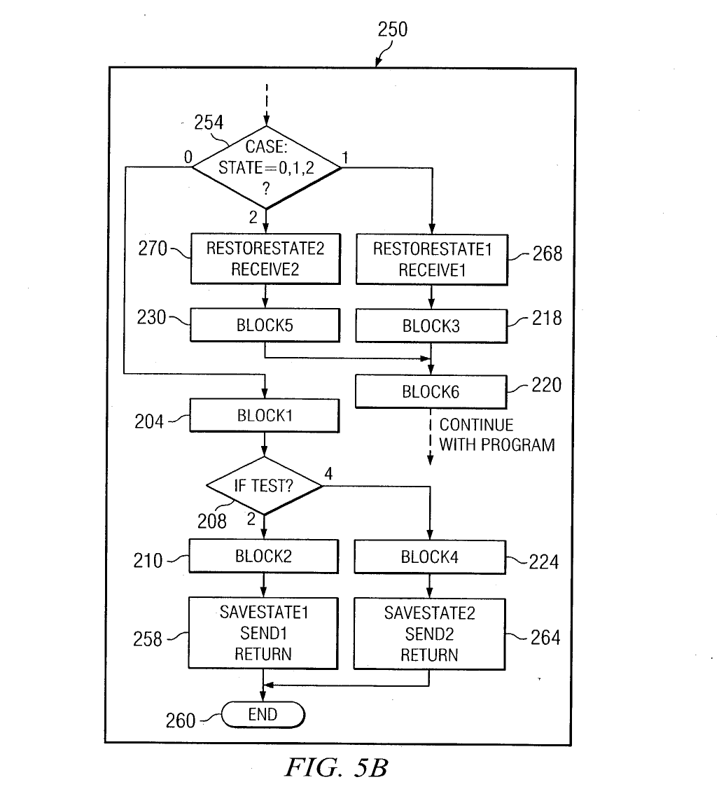

FIG. 5A is a block diagram illustrating example code sets of a conversational program 200 having a decision construct. Program 200 is coded so that a decision code block 208 is executed after the execution of a code block 204. Depending on the result of the decision made by decision code block 208, either code blocks 210, 214, and 218, or code blocks 224, 228, and 230 may be executed, as shown in FIG. 5A. Subsequently, a code block 220 is executed. As shown by FIG. 5A, send and receive code blocks 214 and 228 are respectively included in each leg of decision code block 208. The code blocks shown in FIG. 5A may be coded using any suitable computer language or programming style. An example of a set of commands representing the block diagram shown in FIG. 5A is provided below:

00 BLOCK 1
10 IF TEST 1 THEN
20 BLOCK 2
30 SEND SCREEN 1
40 RECEIVE SCREEN 1
50 BLOCK 3
60 ELSE
70 BLOCK 4
80 SEND SCREEN 2
90 RECEIVE SCREEN 2
100 BLOCK 5
110 END IF
120 BLOCK 6

In the example above, “BLOCK 1,” “BLOCK 2,” “BLOCK 3,” “BLOCK 4,” “BLOCK 5,” and “BLOCK 6” each indicate a particular set of commands operable to perform a particular function.

FIG. 5B is a block diagram illustrating one embodiment of example code sets of a pseudoconversational program 250 that may be generated from conversational program 200 of FIG. 5A using method 150 of FIG. 4. As with program 200, pseudoconversational program 250 includes code blocks 204, 210, 218, 220, 224, and 230. Code blocks 258, 264, 268, and 270 are code sets that have been modified from identified send and receive code blocks 214 and 228 shown in FIG. 5A according to method 150 of FIG. 4.

For example, according to step 168 of method 150 and as shown by block 258, the command “SEND SCREEN 1” located on line “30” shown in the above-provided example commands associated with FIG. 5A is modified so that a state is saved prior to an execution of “SEND SCREEN 1” and further execution of program 250 is halted after the execution of “SEND SCREEN 1.” An analogous modification is made for “SEND SCREEN 2” located on line “80,” as shown by block 264. According to step 170 of method 150, the command “RECEIVE SCREEN 1” on line “40”, which corresponds to command “SEND SCREEN 1” on line “30”, is also modified so that any saved state is restored prior to an execution of “RECEIVE SCREEN 1,” as shown by block 268. An analogous modification is made for “RECEIVE SCREEN 2” on line “90,” as shown by block 270.

According to step 174 of method 150, a state decision block 254 is added to tie the modified send blocks 258 and 264 with the modified receive blocks 268 and 270, as shown in FIG. 5B. State decision block 254 is operable to determine a particular state, if any, that has been previously saved. If state decision block 254 determines that a state of program 250 has not been previously saved, then state decision block 254 is operable to initiate an execution of code blocks 204, 208, and either 210 and 258 or 224 and 264, depending on the determination made at decision block 208. Then the execution of the program halts, as indicated by reference number 260. If state decision block 254 determines that a first state of program 250 has been previously saved, then state decision block is operable to initiate an execution of blocks 268 and 218. If state decision block 254 determines that a second state of program 250 has been previously saved, then state decision block is operable to initiate an execution of blocks 270 and 230. Then block 220 is operable to be executed. In one embodiment, step 278 of method 150 may be omitted because there is no nested decision block in program 200.

The code blocks shown in FIG. 5B may be coded using any suitable computer language or programming style. An example of a set of commands representing the block diagram shown in FIG. 5B is provided below:

10 IF STATE = 0 THEN
20 IF TEST THEN
30 BLOCK 2
40 SAVESTATE 1
50 SEND SCREEN 1
60 RETURN
70 ELSE
80 BLOCK 4
90 SAVESTATE 2
100 SEND SCREEN 2
110 RETURN
120 END IF
130 ELSE IF STATE = 1 THEN
140 RESTORESTATE
150 RECEIVE SCREEN 2
160 BLOCK 3
170 END IF
180 ELSE IF STATE = 2 THEN
190 RESTORESTATE
200 RECEIVE SCREEN 2
210 BLOCK 5
220 END IF
230 BLOCK 6

In the example above, “BLOCK 1,” “BLOCK 2,” “BLOCK 3,” “BLOCK 4,” “BLOCK 5,” and “BLOCK 6” each indicate a particular set of commands operable to perform a particular function.

In a conversational program where a decision block, such as an IF construct, is nested within another decision block, the conversion of the conversational program into a pseudoconversational program may result in certain code blocks that are repeated. Such a repetition creates unnecessary redundancy in programming. In some embodiments of the invention, this redundancy may be minimized by using a procedure call construct. An example of a nested IF construct in a conversational program is provided below.

10 IF TEST1 THEN
20 BLOCK 1
30 IF TEST 2 THEN
40 BLOCK 2
50 SEND 1
60 RECEIVE 1
70 BLOCK 3
80 ELSE
90 BLOCK 4
100 END IF
110 BLOCK 6
120 ELSE
130 BLOCK 5
140 END IF
150 BLOCK 7

Using method 150 described in FIG. 4, the above example may be converted into the following pseudoconversational program.

10 IF STATE=0 THEN
20 IF TEST1 THEN
30 BLOCK 1
40 IF TEST2 THEN
50 BLOCK 2
60 SEND 1
70 SAVESTATE 1
80 SEND 1
90 RETURN
100 ELSE
110 BLOCK 4
120 END IF
130 BLOCK 6
140 ELSE
150 BLOCK 5
170 END IF
180 ELSE IF STATE=1 THEN
190 RESTORESTATE
200 RECEIVE 1
210 BLOCK 3
220 BLOCK 6
230 END IF
240 BLOCK 7

As shown immediately above on lines “130” and “220,” “BLOCK 6” is repeated twice. In some embodiments, to eliminate the repetition of the code block referred to as “BLOCK 6,” a procedure code set may be established that includes a copy of code block referred to as “BLOCK 6.” Then, a command for initiating the procedure code set may be coded repeatedly rather than coding the entire “BLOCK 6” code set repeatedly. An example of such a modification using a procedure call is shown below.

10 IF STATE=0 THEN
20 IF TEST1 THEN
30 BLOCK 1
40 IF TEST2
50 BLOCK 2
6O SEND 1
70 SAVESTATE 1
80 SEND 1
90 RETURN
100 ELSE
110 BLOCK 4
120 END IF
130 PERFORM P1
140 ELSE
150 BLOCK 5
170 END IF
180 ELSE IF STATE=1 THEN
190 RESTORESTATE
200 RECEIVE 1
210 BLOCK 3
220 PERFORM P1
230 END IF
240 BLOCK 7
250 EXIT.
260 P1.
270 BLOCK 6

While the elimination of programming redundancy that may result from converting a conversational program having a nested decision construct to a pseudoconversational program may be desired, it is not a necessary element to the teachings of the present invention.

Conversational programs often employ one or more procedures for programming efficiency. In some cases, the procedure may include a send command followed by a corresponding receive command, and thus may require conversion into a pseudoconversational format. An example of a procedure in a conversational format is provided below:

10 BLOCK1
20 PERFORM P1
30 BLOCK2
40 PERFORM P1
50 BLOCK3
60 EXIT
70
90 SEND
100 RECEIVE
110 BLOCK11

This example is referred to herein as “example program A.” As shown above, procedure “P1” in lines “80”through “110” shown above includes a “SEND” command in line “90” and a corresponding “RECEIVE” command in line “100.” Procedure call commands, such as “PERFORM P1” in lines “20” and “40,” may be used to initiate an execution of procedure “P1.” Procedure “P1” may be converted into a pseudoconversational format using method 150 of FIG. 4. To enable the program to return to a certain point in the flow of the program after each execution the converted procedure, return addresses may need to be saved. For example, after procedure “P1” is executed as a result of executing procedure call command “PERFORM P1” in line “20”, the program needs to return to a point where it can continue with an execution of “BLOCK2” in line “30” in order to properly function.

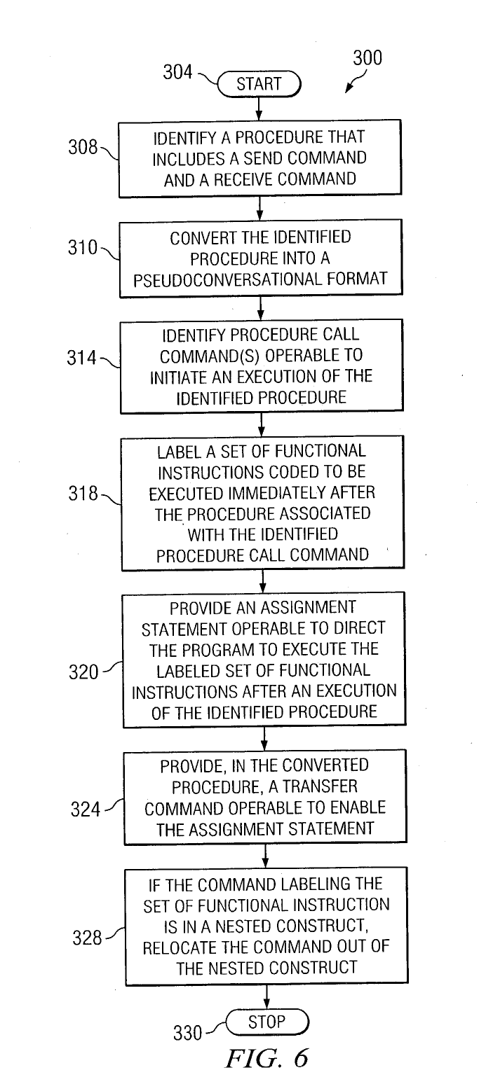

FIG. 6 is a flowchart illustrating one embodiment of a method 300 for converting a conversational procedure, such as “P1” in example program A, into a pseudoconversational format that is operable to return the program back to a code block that is coded to be executed after an execution of the procedure. To do this, a return address is saved using a new variable, such as “NEXT-P,” in conjunction with an execution of the converted procedure. Using method 300, example program A may be converted into an example program below:

10 IF STATE= 0 THEN
20 GOTO L0
30 ELSE
40 GOTO P1.
50 END IF
60 EXIT.
70
80 P1 IF STATE = 0 THEN
90 BLOCK10
100 SAVESTATE 1
110 SEND
120 RETURN
130 ELSE
140 RESTORESTATE 1
150 RECEIVE
160 BLOCK11
170 ENDIF
180 GOTO NEXT-P1
190
200 L0 BLOCK1
210 NEXT-P1 = L1
220 PERFORM P1
230 L1 BLOCK2
240 NEXT-P1 = L2
250 PERFORM P1
260 L2 BLOCK3

This example program is referred to herein as “example program B.” Method 300 is described in conjunction with example programs A and B. Some or all of the acts of method 300 may be implemented using program 90; however, any other suitable software or hardware implementation may be used.

Method 300 starts at step 304. At step 308, a procedure that includes a send command and a corresponding receive command is identified. For example, “P1” in lines “80” through “110” of example program A may be identified because “P1” includes “SEND” in line “90” and “RECEIVE” in line “100.” At step 310, the identified procedure is converted into a pseudoconversational format using method 150 of FIG. 4. An example of the conversion in step 310 is shown as “P1” in lines “80” through “180” of example program B. Additional details concerning the command in line “180 of example program B is provided below. At step 314, one or more procedure call commands operable to initiate an execution of the identified procedure are identified. For example, “PERFORM P1” in lines “20” and “40” of example program A are identified at step 314. At step 318, a label identifying a set of functional instructions that are coded to be executed immediately after an execution of the procedure is provided. For example, “BLOCK2” and “BLOCK3” in respective lines “30” and “50” of example program A are respectively labeled as “L1” and “L2,” as shown in lines “210” and “240” of example program B.

At step 320, an assignment statement operable to direct the program to execute the labeled code blocks after an execution of the identified procedure is provided. In one embodiment, this may be done by an assignment statement that assigns to the new variable the labels assigned to code blocks. For example, assignment statement “NEXT-P1=L1” may be provided immediately prior to the procedure call command “PERFORM P1” in line 20 of example program A. “NEXT-P1=L1” assigns label “L1,” which labels “BLOCK2”, to new variable “NEXT-P1”. An example of this is shown in line “210” of example program B, where the assignment statement is provided immediately prior to an identified procedure call command “PERFORM P1” in line “220.” Thus, the assignment statement is operable to be executed immediately prior to an execution of the procedure call command in line “220.” Similarly, for the identified procedure call command of “PERFORM P1” in line “40,” an assignment statement assigning label “L2” to new variable “NEXT-P1” may be provided immediately prior to the procedure call command so that the assignment statement is operable to be executed immediately prior to an execution of the procedure call command in line “40.” As described above, “L2” is assigned to “BLOCK3.” An example of this is shown in line “240” of example program B, where the assignment statement is provided immediately prior to an identified procedure call command “PERFORM P1” in line “250.” Thus, the assignment statement is operable to be executed immediately prior to an execution of the procedure call command in line “250.”

At step 324, a transfer command operable to return the program to an appropriate point in the flow of the program according to the assignment statements is provided for the converted procedure. For example, a transfer command of “GOTO NEXT-P1” is provided in line “180” of example program B as a part of converted procedure “P1” shown in lines “80” through “180” of example program B. Thus, after an execution of “P1,” the program is directed to a code block identified by a particular label by the transfer command. The transfer command follows the assignment statement that is executed immediately prior to the execution of procedure “P1.” Thus, the assignment statement is used to save the address of the portion of the program that is coded to be executed after a particular execution of a procedure.

At step 328, any labeled code set that may be in a nested construct (an “IF” construct, for example) is relocated out of the nested construct. This may be necessary when the conversational program is written in computer languages, such as COBOL, that does not allow labeled code sets within a nested construct. For example, if labeled code sets “BLOCK2” and “BLOCK3” in respective lines “30” and “50” of example program A were to be in a nested construct that may result from the conversion of the program using method 150 of FIG. 4, the labeled code sets may need to be relocated out of the nested construct, as shown in lines “200” through “260” of example program B. To preserve the original program flow and accommodate the relocation, the first code block (“BLOCK1”) of the relocated code set (shown in lines “200” through “260” of example program B) is labeled with “L0,” as shown in line “200” of example program B. Then a transfer command using the label is coded to be executed at the point of program flow when the relocated code set is normally executed. For example, a transfer command, such as “GOTO L0,” is coded in line “20” of example program B along with any appropriate support commands to direct the program to the code set in lines “200” through “260.” Method 300 stops at step 330. In one embodiment, method 300 may be performed repetitively until all conversational procedures are converted into a pseudoconversational format.

Although some embodiments of the present invention have been described in detail, it should be understood that various changes, substitutions, and alterations can be made hereto without departing from the spirit and scope of the invention as defined by the appended claims.

What is claimed is:

1. A computerized method for converting a conversational program to a pseudo-conversational program, comprising:
providing a conversational program comprising a first code set, a second code set, and a send and receive code set, the first code set coded to be executed prior to an execution of the send and receive code set, and the second code set coded to be executed subsequent to the execution of the send and receive code set, the send and receive code set comprising a send command and a corresponding receive command, the send command operable to send a request and the corresponding receive command operable to receive a response to the request;
identifying the send and receive code set and further identifying the send command and the corresponding receive command;
inserting a first command at a first location in a program flow where the first command will be executed before execution of the send command, the first command operable to save a state of a program;
inserting a second command at a second location in the program flow where the second command will be executed after the execution of the send command but before execution of the receive command, the second command operable to stop an execution of the program;
inserting a third command at a third location in the program flow where the third command will be executed before the execution of the receive command but after execution of the second command, the third command operable to restore a previously saved state of the program; and
providing a state decision command operable to initiate an execution of the first command, the send command, and the second command when no state has been previously saved, and the third command and the receive command when a state has been previously saved.

2. The method of claim 1, wherein the first command is operable to save at least one variable that will be used by the program after an execution of the receive command.

3. The method of claim 1, wherein the first location is a location in the program flow where the first command will be executed immediately before the execution of the send command, and the second location is a location in the program flow wherein the second command will be executed immediately after the execution of the second command.

4. The method of claim 1, wherein the third location is a location in the program flow wherein the third command will be executed immediately before the execution of the receive command.

5. The method of claim 1, wherein the send and receive code set is included in a procedure block of the conversational program, the procedure block associated with a procedure call command, and wherein the second code set is coded to be executed immediately after the execution of the procedure call command, and further comprising:
labeling the second code set with a unique identifier;
providing an assignment statement operable to be executed immediately prior to an execution of the procedure call command, the assignment statement assigning the unique identifier to a variable; and
providing a transfer command operable to direct the program flow to the second code block using the variable immediately after an execution of the procedure block.

6. The method of claim 1, wherein the first command is operable to save only a plurality of variables that will be used after the execution of the receive command, and the third command is operable to restore only the plurality of variables saved using the first command.

7. The method of claim 1, wherein the conversational program comprises a first decision code set nested in a second decision code set, and further comprising:
providing a procedure code set, the procedure code set including a copy of the second code set; and
replacing the second code set with a procedure call commend operable to initiate an execution of the procedure code set.

8. A computerized method for converting a conversational program to a pseudo-conversational program, comprising:
identifying a send command and a corresponding receive command in the conversational program;
modifying the conversational program to save a state of the conversational program prior to an execution of the send command and to stop execution after the execution of the send command without executing the receive command; and
modifying the conversational program to restore, when an input is received in response to executing the send command, any saved state prior to execution of the receive command.

9. The method of claim 8, wherein modifying the conversational program to save a state comprises providing a command operable to save at least one variable that will be used after an execution of the receive command.

10. The method of claim 8, wherein modifying the conversational program to save a state comprises providing a command operable to save a plurality of live variables that will be used after an execution of the receive command, and not save any variables that will not be used after the execution of the receive command.

11. The method of claim 8, wherein modifying the conversational program to save a state comprises:
inserting a first command operable to save the state at a location in a program flow where the first command will be executed prior to an execution of the send command; and
inserting a second command operable to stop an execution of a program at a location in the program flow where the second command will be executed after the execution of the send command.

12. The method of claim 8, wherein modifying the conversational program to restore any saved state comprises inserting a command operable to restore any saved state at location in a program flow where the command will be executed before an execution of the receive command.

13. The method of claim 8, wherein the send command and the receive command are included in a procedure block of the conversational program, the procedure block associated with a procedure call command in the conversational program, and further comprising:
identifying a code set in the conversational program that is coded to be executed immediate after the execution of the procedure call command;
labeling the code set with a unique identifier;
providing an assignment statement operable to be executed immediately prior to an execution of the procedure call command, the assignment statement assigning the unique identifier to a variable; and
providing a transfer command operable to direct the program flow to the code block using the variable immediately after an execution of the procedure block.

14. The method of claim 8, wherein the conversational program comprises a first decision code set nested in a second decision code set and a code set coded to be executed subsequent to an execution of the receive command, the first decision code set including the send command and the receive command, and further comprising:
providing a procedure code set, the procedure code set including a copy of the code set; and
replacing the code set with a procedure call command that is operable to execute the procedure code set.

15. The method of claim 8, wherein the conversational program comprises a plurality of send commands and a corresponding plurality of receive commands, and wherein:
modifying the conversational program to save a state comprises, for each of the send commands, modifying the conversational program to save a state prior to the execution of each send command; and
modifying the conversational program to restore any saved state comprises, for each of the receive commands, modifying the conversational program to restore, when the input is received in response to executing the each send command, any saved state prior to the execution of each receive command.

16. The method of claim 8, wherein a first portion of the conversational program modified to save a state, execute the send command, and stop execution after the execution of the send command without executing the receive command is a first code set and a second portion of the conversational program modified to restore any saved state and execute the receive command is a second code set, and further comprising providing a state decision code set operable to:
determine that no previously saved state is available, and in response, initiate an execution of the first code set; and
determine that a previously saved state is available, and in response, initiate an execution of the second code set.

17. A system for converting a conversational program stored in a data storage medium to a pseudoconversational program, comprising:
a computer system having a processor;
a computer readable medium coupled to the computer system, the computer readable medium comprising a program operable, when executed on the processor, to:
identify a send command and a corresponding receive command in the conversational program;
modify the conversational program to save a state of the conversational program prior to an execution of the send command and to stop execution after the execution of the send command without executing the receive command; and
modify the conversational program to restore, when an input is received in response to executing the send command, any saved state prior to execution of the receive command.

18. The system of claim 17, wherein the program is operable to modify the conversational program to save a state by providing a command operable to save at least one variable that will be used after an execution of the receive command.

19. The system of claim 17, wherein the program is operable to modify the conversational program to save a state by providing a command operable to save a plurality of live variables that will be used after an execution of the receive command, and to not save any variables that will not be used after the execution of the receive command.

20. The system of claim 17, wherein the program is operable to modify the conversational program to save a state by:
inserting a first command operable to save the state at a location in a program flow where the first command will be executed prior to an execution of the send command; and
inserting a second command operable to stop an execution of the pseudoconversational program at a location in the program flow where the second command will be executed after the execution of the send command.

21. The system of claim 17, wherein the program is operable to modify the conversational program to restore any saved state by inserting a command operable to restore any saved state at location in a program flow where the command will be executed before an execution of the receive command.

22. The system of claim 17, wherein the program is operable to modify the conversational program to restore any saved state by inserting a command operable to restore one or more variables that will be used after the execution of the receive command, the command inserted at a location in a program flow where the command will be executed before an execution of the receive command.

23. The system of claim 17, wherein the conversational program comprises a first decision code set nested in a second decision code set and a code set coded to be executed subsequent to an execution of the receive command, the first decision code set including the send command and the receive command, and wherein the program is operable to:
provide a procedure code set, the procedure code set including a copy of the code set; and
replace the code set with a procedure call command that is operable to execute the procedure code set.

24. The system of claim 17, wherein the conversational program comprises a plurality of send commands and a corresponding plurality of receive commands, and wherein the program is operable to:
modify the conversational program to save a state by modifying the conversational program to save a state prior to the execution of each of the send commands; and
modify the conversational program to restore any saved state by modifying the conversational program to restore, when the input is received in response to executing each of the send commands, any saved state prior to the execution of each of the receive commands.

25. The system of claim 17, wherein a first portion of the conversational program modified to save a state, execute the send command, and stop execution after the execution of the send command without executing the receive command is a first code set and a second portion of the conversational program modified to restore any saved state and execute the receive command is a second code set, and wherein the program is operable to provide a state decision code set operable to:
determine that no previously saved state is available, and in response, initiate an execution of the first code set; and
determine that a previously saved state is available, and in response, initiate an execution of the second code set.

26. Software for converting a conversational program stored in a data storage medium to a pseudoconversational program, the software embodied in computer-readable media and when executed operable to:
identify a send command and a corresponding receive command in the conversational program;
modify the conversational program to save a state of the conversational program prior to an execution of the send command and to stop execution after the execution of the send command without executing the receive command; and
modify the conversational program to restore, when an input is received in response to executing the send command, any saved state prior to execution of the receive command.

27. The software of claim 26, wherein the state of the conversational program comprises a plurality of variables that will be used after the execution of the receive command, and not any variables that will not be used after the execution of the receive command.

28. The software of claim 26, wherein the send command is operable to send a web page requesting information to a computer.

29. A computerized method for converting a conversational program to a pseudo-conversational program, comprising:
identifying a procedure having send command and a corresponding receive command in the conversational program;
identifying a procedure call command operable to initiate an execution of the procedure immediately prior to an execution of a code set;
modifying the conversational program to save a state of the conversational program prior to an execution of the send command and to stop execution after the execution of the send command without executing the receive command;
modifying the conversational program to restore, when an input is received in response to executing the send command, any saved state prior to execution of the receive command;
labeling the code set with a unique identifier;
providing an assignment statement operable to be executed immediately prior to an execution of the procedure call command, the assignment statement assigning the unique identifier to a variable; and
providing a transfer command operable to use the variable to direct the program flow to the code block immediately after an execution of the procedure.

30. The method of claim 29, and further comprising relocating the labeled code set out of any nested constructs within the resulting pseudoconversational program.
